(19) United States
(12) Patent Application Publication
(10) Pub. No.: US 2019/0028133 A1
(43) Pub. Date: Jan. 24, 2019

(54) COVER FOR SMARTPHONES OR TABLET COMPUTERS

(71) Applicant: AIRSELFIE HOLDINGS LIMITED, London (GB)

(72) Inventor: Marco STROPPIANA, London (GB)

(73) Assignee: AIRSELFIE HOLDINGS LIMITED, London (GB)

(21) Appl. No.: 16/065,495

(22) PCT Filed: Nov. 11, 2016
(86) PCT No.: PCT/IB2016/056797

§ 371 Date: Jun. 22, 2018

(30) Foreign Application Priority Data
Dec. 23, 2015 (IT) 102015000086959

(51) Int. Cl. H04B 1/3888; H04M 1/725; H04M 1/21; B64C 39/02

(52) U.S. Cl. CPC H04B 1/3888; H04M 1/72527; H04M 1/21; B64C 39/024; B64C 39/028; B64C 2201/146; B64C 2201/20; B64C 2201/108; B64C 2201/042; B64C 2201/024; B64C 2201/127

(57) ABSTRACT

A cover for a mobile device, in particular a smartphone or a tablet computer, includes an aerial device provided with a camera, which is removably housed within a cavity made in said cover. The aerial device can be recharged by one or more batteries contained in the cover, which can also supply the mobile device itself.

### FIELD OF THE INVENTION

The present invention relates to a cover for mobile devices, in particular for smartphones or tablets. By “cover” is to be understood herein the shell or half-shell sold as accessory for smartphones or tablet computers that is designed to house these devices to protect integrity thereof, for example in the event of them being dropped.

### RELEVANT PRIOR ART

The smartphone and tablet-computer devices in question are today tools that have innumerable functions and are by now able to offer an aid to the user in any context whether for working activities, for the home environment, or for entertainment, etc.

One of the most widely used functions is certainly the camera, also thanks to the fact that the quality achieved by microcameras today installed in these devices has reached a level altogether comparable with that of traditional cameras.

Around this function there have thus developed, in the latter years, various accessories that enable implementation of the camera function in the most varied ways.

In this connection, the so-called “selfie stick” has obtained a success that can be defined as planetary, this being an extendable telescopic stick provided on one end of which is a bracket on which the cellphone can be fixed, and provided on the grip of which is a button via which it is possible control the button of the camera of the cellphone fixed on the bracket.

This device is principally used for self-portrait photographs, the so-called “selfies”. The patents filed regarding devices of this type are numerous and among these we may cite, by way of example, CN 204258897, CN 204258894, CN 204258874, CN 104819371, and CN 104836874.

Notwithstanding the success obtained, the selfie stick presents various drawbacks, amongst which its encumbrance, and the fact that it is an element separate from the cellphone so that the user has to remember to carry it along with him in the case where he might wish to use it. These drawbacks are at least partially overcome by the solution presented in the document KR 2004-78259, which is a cover for smartphones having an integrated selfie stick.

### OBJECT AND SUMMARY OF THE INVENTION

In the above context, the object of the present invention is to provide a new accessory that will overcome the drawbacks indicated above and that will moreover afford new functions and possibilities of use of the associated mobile device.

The object indicated above is achieved via a cover for smartphones or tablet computers having the characteristics specified in claim 1.

The characteristics indicated in the claims form an integral part of the technical teaching provided herein.

### BRIEF PRESENTATION OF THE DRAWINGS AND DETAILED DESCRIPTION OF SOME EMBODIMENTS

Further characteristics and advantages of the present invention will emerge clearly from the ensuing description with reference to the annexed drawings, which are provided purely by way of non-limiting example and in which:

FIGS. 1A and 1B are perspective views of a first embodiment of the cover described herein, in two respective different conditions of use;

FIGS. 2A and 2B are perspective views of a second embodiment of the cover described herein, in two respective different conditions of use;

FIG. 3 illustrates a third embodiment of the cover described herein;

FIG. 4 illustrates a fourth embodiment of the cover described herein;

FIG. 5 illustrates a fifth embodiment of the cover described herein;

FIGS. 6 and 7 are partially exploded perspective views of a first embodiment and a second embodiment, respectively, of an aerial device associated to the cover described herein;

FIG. 8 is a perspective view of a third embodiment of an aerial device associated to the cover described herein;

FIG. 9 illustrates a detail of FIG. 1A;

FIG. 10 illustrates a fourth embodiment of the aerial device described herein;

FIG. 11 illustrates a sixth embodiment of the cover described herein; and

FIG. 12 illustrates a seventh embodiment of the cover described herein.

In the ensuing description, various specific details are illustrated aimed at enabling an in-depth understanding of the embodiments. The embodiments may be provided without one or more of the specific details, or with other methods, components, or materials, etc. In other cases, known structures, materials, or operations are not shown or described in detail so that various aspects of the embodiment will not be obscured.

The references used herein are only provided for convenience and hence do not define the sphere of protection or the scope of the embodiments.

As anticipated above, the solution described herein is a cover for mobile devices, in particular for smartphones and tablet computers.

By the term “cover” is here understood any structure that is configured for housing the mobile device and has a function of protection thereof.

The terms “smartphone” and “tablet computer” are by now widely used and indicate a particular category of mobile devices. In general, these devices are characterized in that they comprise one or more processors connected to one or more memories and moreover at least one communication interface for communication with a base station, such as a GSM, UMTS, or LTE transceiver, and a user interface, such as a touch screen. For example, in the memory there may be stored an operating system that is executed by the processor and manages the general functions of the mobile device, such as management of the user interface and setting-up of a connection with the base station via the communication interface, also including management of the IP protocol. The memory may also contain applications that are executed by the operating system; for example, the memory may comprise a web-browser application. Usually, the devices in question moreover comprise a short-to-medium range communication interface (e.g., with a range of up to 200 m), for example a communication interface in accordance with the Wi-Fi standard (IEEE 802.11) or else Bluetooth standard or equivalent technologies.

To return to the cover, it may present a shell or half-shell structure and may possibly be provided with a flap that closes like a book for covering the device totally when it is not used.

The cover described herein—designated in the figures by the reference number 2—is characterized in that it comprises an aerial device 4 provided with camera 6, which is carried by the cover that can be removed therefrom for being used as aerial camera of the mobile device—the latter being represented in the figures, by way of example, in the form of smartphone and designated by the reference number 10. The aforementioned camera may be constituted by any image-acquisition device that can be operated as photographic camera and possibly also as video camera.

The aerial device in question is a small drone that can be driven by the mobile device and is able to fly, via propeller means of its own, up to a given distance from the mobile device. Preferably, the aerial device has a wireless communication interface, preferably a short-to-medium range one (e.g., up to 200 m), for example a communication interface that complies with the Wi-Fi standard (IEEE 802.11) or else the Bluetooth standard or equivalent technologies.

The above communication interface is configured for receiving commands from the mobile device and for sending the images acquired by the camera of the aerial device to the mobile device. Preferably, the aforesaid transmission of images takes place in real time, and the mobile device is configured for displaying on its own screen the images transmitted, in such a way that the user can see in real time the shots made by the aerial device.

The mobile device can then be configured for controlling the camera of the aerial device and for saving to memory the images taken by the camera.

In the light of what has been said above, it is hence evident that the aerial device in question may to all effects and purposes operate as an aerial camera of the mobile device.

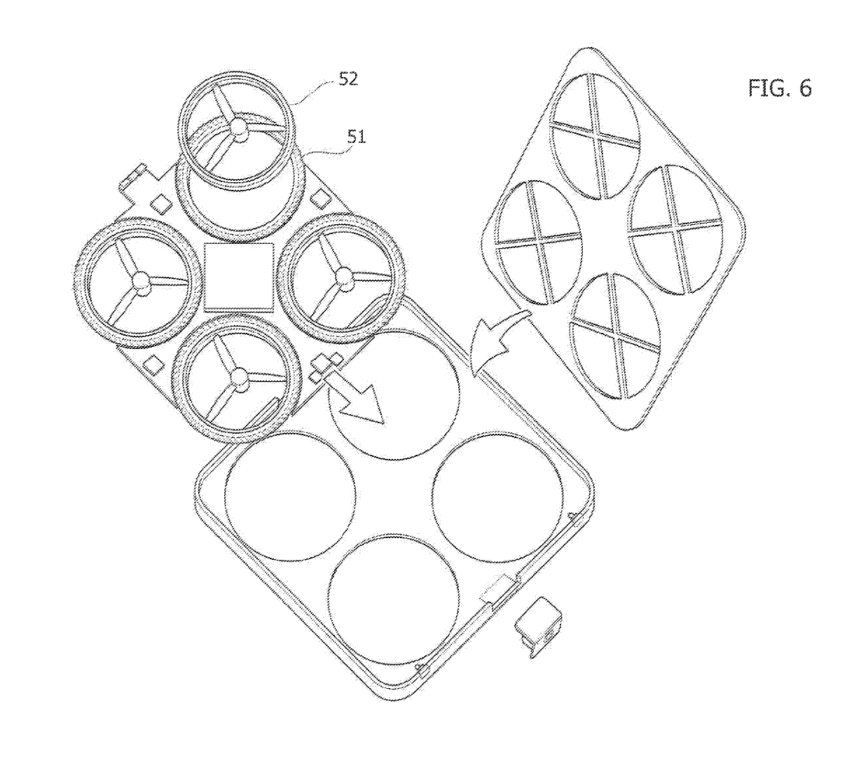

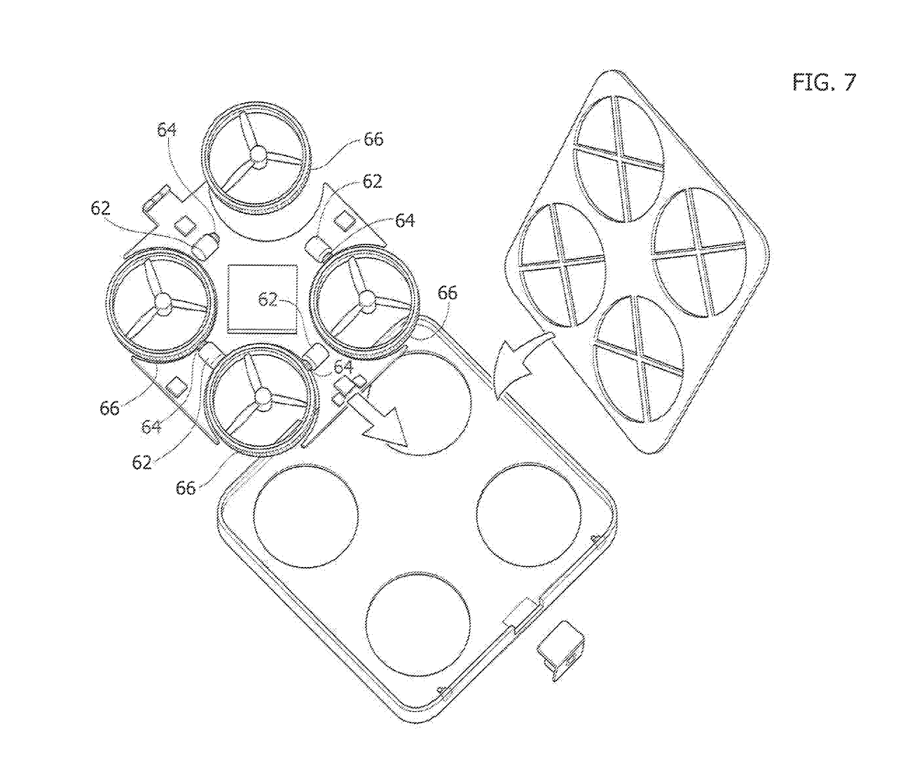

In a first embodiment (see FIGS. 6 and 7), the aerial device 4 has a generally planar body 42, having a profile in plan view that is preferably rectangular or square, made on which are a plurality of through openings 44 that each house a corresponding rotor 46 provided with blades, designed to operate as propeller of the device.

The various rotors of the device are driven by respective battery-supplied electric motors.

As may be seen from FIGS. 6 and 7, the electric motors in question may present various configurations. In particular, with reference to FIG. 6, these motors may present an annular configuration in which the electric windings of the motor are carried by a first ring 51 fixed to the structure of the device, whereas the rotor has a second ring 52, which surrounds the blades of the rotor and carried on which are, instead, the magnetic elements designed to co-operate with the aforesaid electric windings. The second ring of the rotor is mounted according to a rotatable coupling within the first ring fixed to the structure of the device.

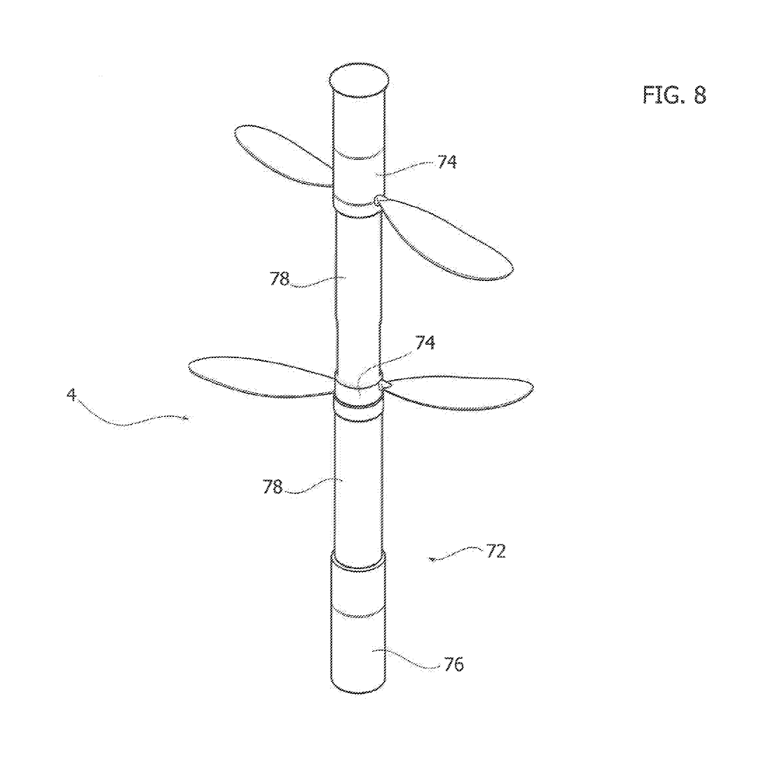

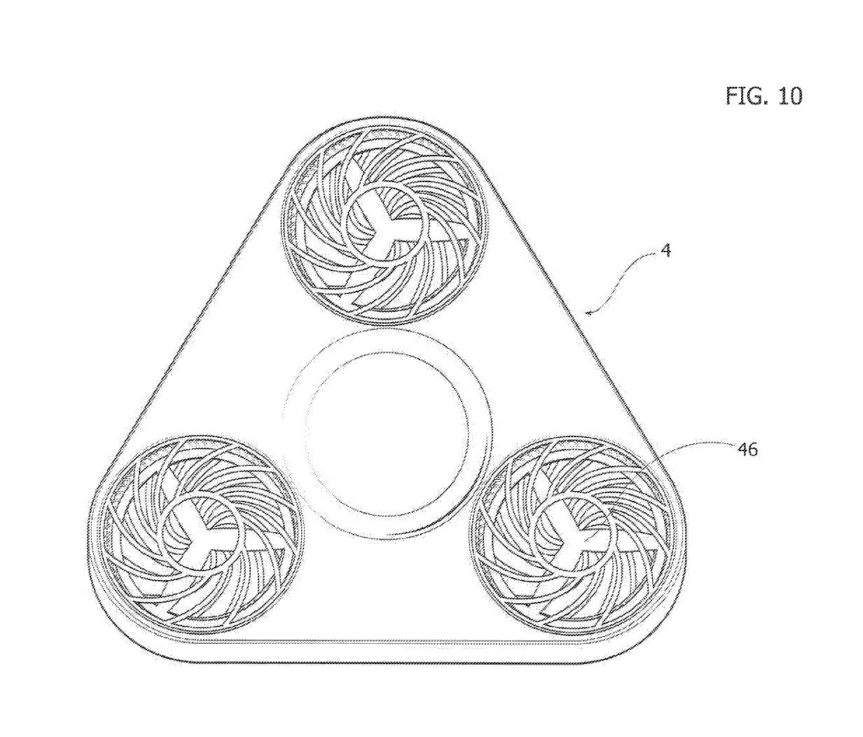

With reference to FIG. 8, in the solution illustrated therein, the electric motors are instead rotary electric motors of a conventional type 62, fixed on the shaft of which is a pinion 64 designed to engage an external toothing 66 made on a ring of the rotor similar to the second ring indicated above of the previous alternative solution. FIG. 10 illustrates an aerial device similar to the ones described above that differs from these only in that it has three rotors, instead of four, arranged at the vertices of a body of a triangular shape.

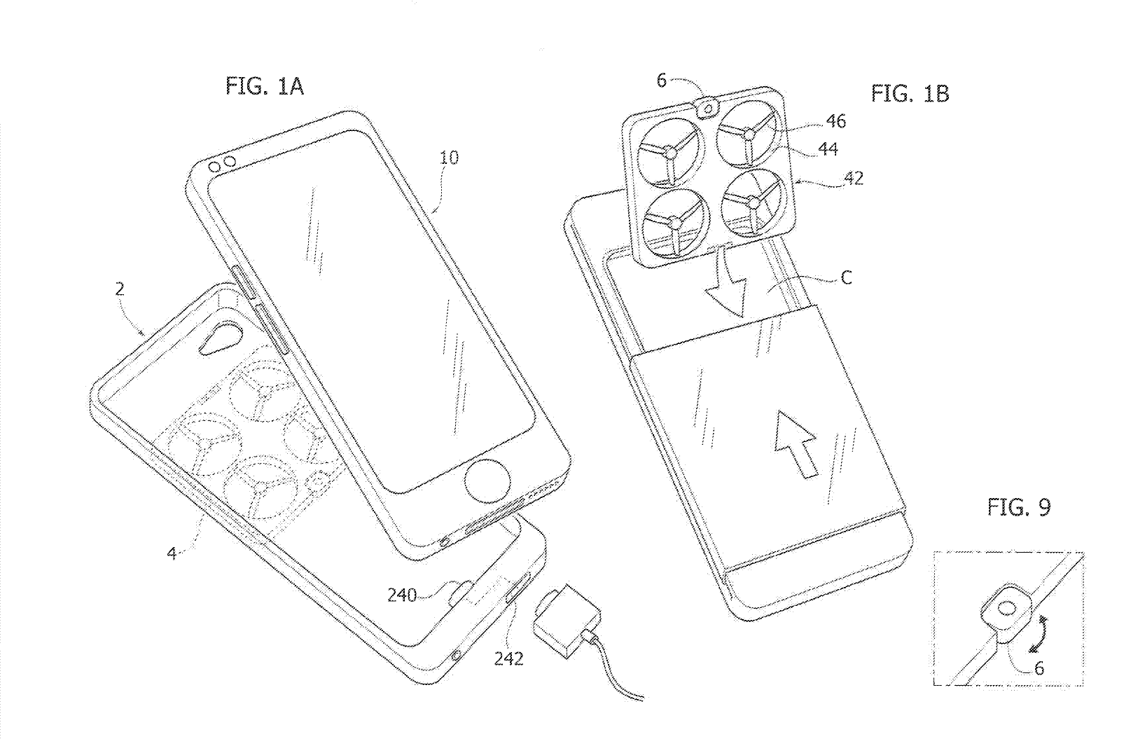

As may be seen from FIGS. 1a to 5, the aerial device in question is characterized in that it presents very small transverse dimensions so that it can be housed within an internal cavity C of the cover.

As visible in the figures, this cavity may be provided in different positions.

In the solution illustrated in FIG. 1, the cavity in question is made on the rear side of the cover and is closed by a sliding hatch.

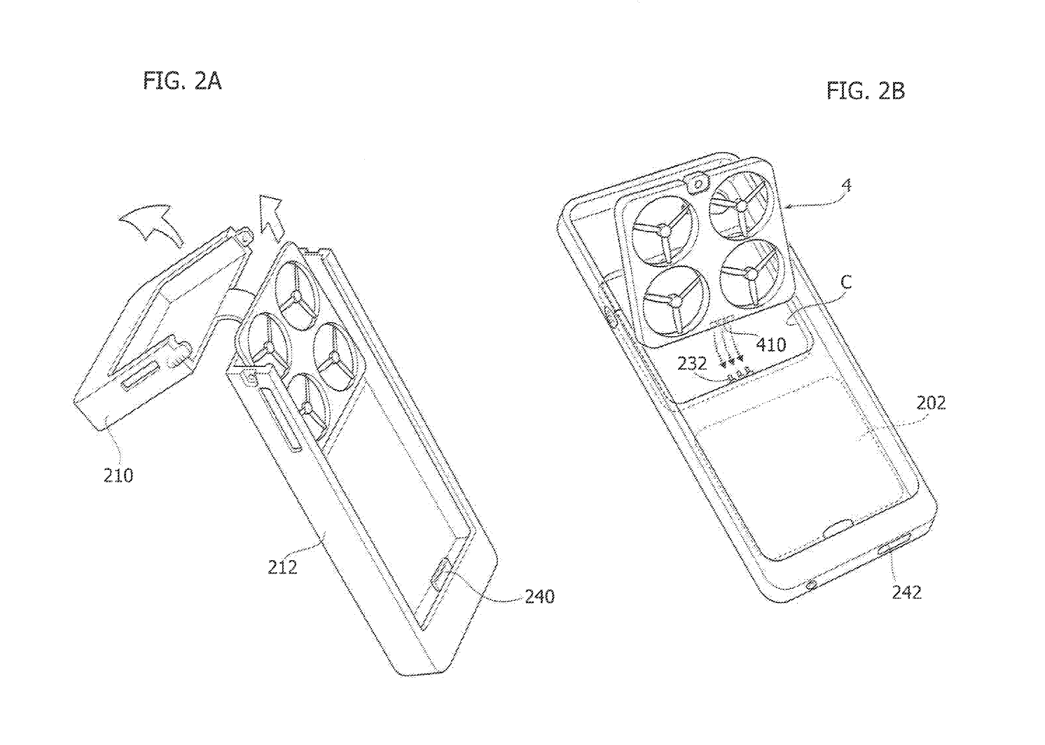

In the solution of FIG. 2A, the cavity is instead made on the inner side of the cover. In this solution, the cover 2 is constituted by a top part 210 and a bottom part 212, which each define a portion of the cavity and which are connected together by a flexible tab that enables lateral displacement of the top part so as to facilitate insertion of the device into the cavity. The two parts of the cover then have respective slot-fit portions for mutual fixing.

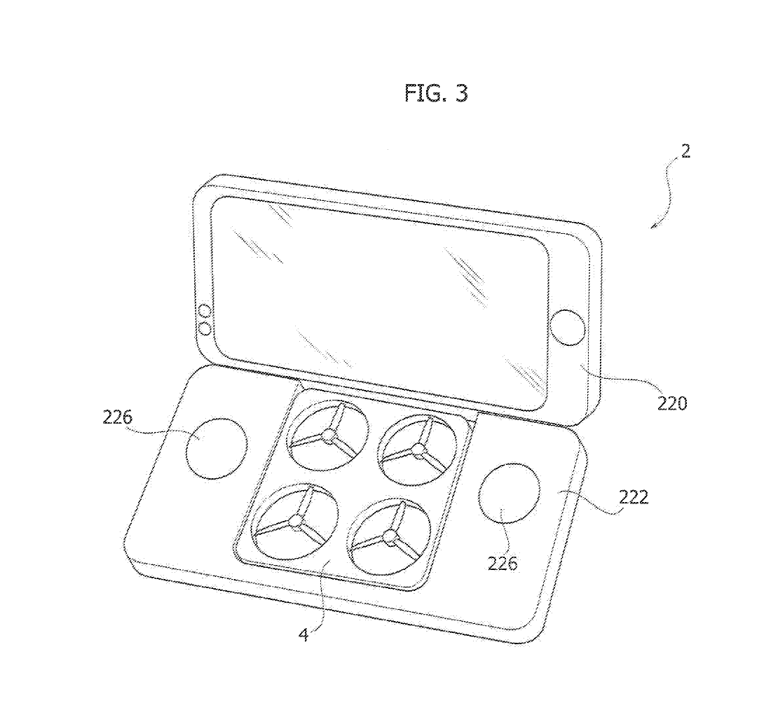

In the solution of FIG. 3, the cover has a generic book-like structure comprising a shell 220 in which the smartphone is to be housed and a covering 222 that can be turned open and closed, housed within which is the aerial device. This covering is moreover provided with controls 226 for control of the device during its use via radiofrequency control signals.

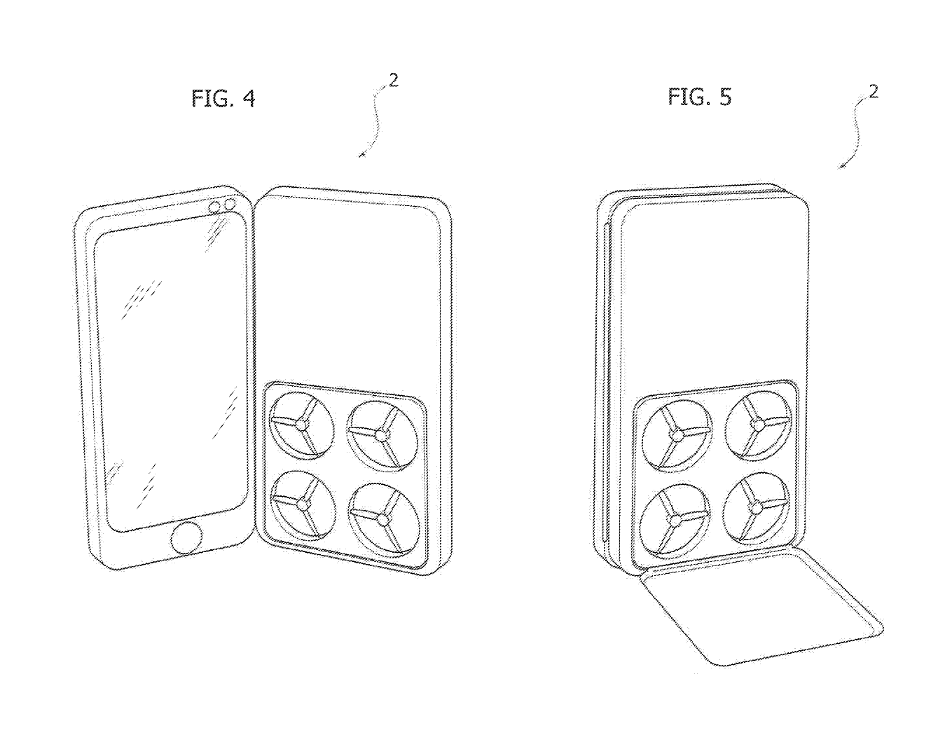

A similar solution is illustrated in FIGS. 4 and 5, but in this case the rotatable covering is without control buttons; in the solution of FIG. 5, the cavity is made in the outer side of the covering and is closed by a hatch that can be turned open and closed.

In further solutions (not illustrated), the cavity for housing the aerial device is made inside the shell that houses the smartphone itself and is accessible from outside only through a slit made either on the bottom edge of the shell or else on one of its two lateral edges.

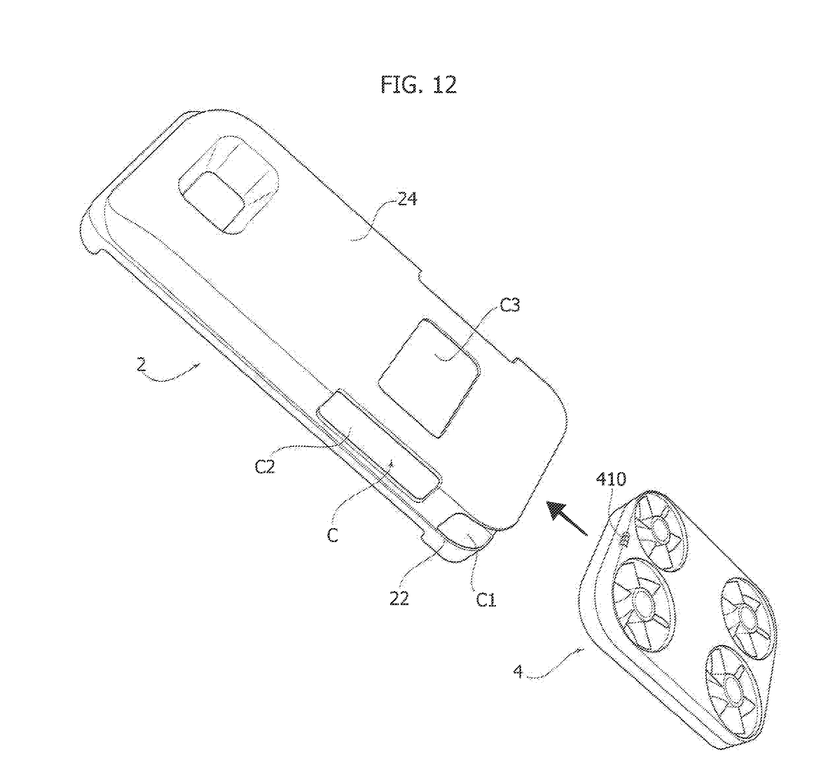

In this connection, with reference to the embodiment of FIG. 12, here the cover 2 has the generic shape of a flattened parallelepiped. The two major sides 22 and 24 define, the former, the base wall on which the cellphone rests on its outer side, and the latter the bottom wall of the cover.

The cavity C is made between the two major sides 22 and 24 and extends substantially throughout the width of the sides, and in the longitudinal direction of these, for a length sufficient for housing the device 4 completely. The cavity C is accessible from the outside through a first slit C1, through which the aerial device 4 can be inserted within the cavity and which is made on a bottom side of the cover 2 orthogonal to the longitudinal direction thereof.

In various preferred embodiments, as in the one illustrated, the cavity C is moreover accessible from outside through two lateral slits C2, which are made on the major side 24, in two opposite lateral regions thereof and/or, at least partially, in the two opposite bottom sides of the cover parallel to its longitudinal direction. These slits C2 leave exposed on the outside the corresponding underlying edges of the aerial device 4, which can hence be gripped by the user for taking out the device, thus facilitating removal of the device from the cavity C. Possibly, moreover provided on the major side 24 or else on the major side 22 is an opening C3 pre-arranged for rendering visible from outside a corresponding central part of the aerial device 4, for purely aesthetic purposes.

According to an alternative embodiment (see FIG. 8), the aerial device in question has, instead, a generally cylindrical body 72 constituted by two rotors 74 set on top of one another, provided with blades, which represent the propellers of the device, and by a base body 76 rotatably mounted on which are the two rotors and housed within which are the battery, the control unit of the device, and the electric motors designed to drive the two rotors. Preferably, the blades of the two rotors are collapsible in such a way that the aerial device can assume a configuration of reduced dimensions when it is not used. In various preferred embodiments, as in the one illustrated, the base body defines at each rotor a portion 78 with small external diameter, housed within which is the respective electric motor for driving the rotor, and which defines on the outside a seat received within which are the blades of the rotor when they are arranged in the collapsed condition. The blades can be driven into the operative position by springs and be, instead, designed to be brought into the collapsed condition manually by the user. In this case, the aerial device may envisage a manually operable blocking member designed to withhold the blades in the collapsed condition.

In a way similar to the aerial device of the first embodiment, this aerial device is pre-arranged for being housed within a cavity, in this case cylindrical, made in the cover.

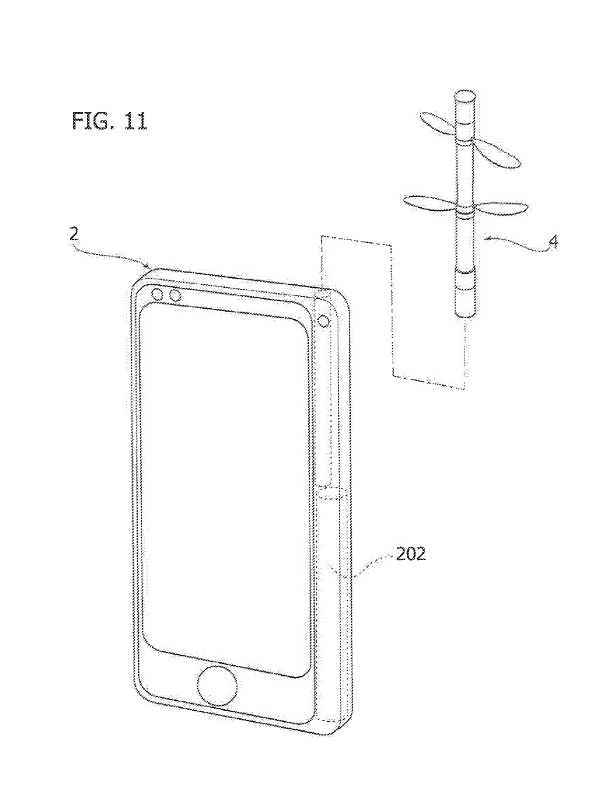

According to an important characteristic of the present invention, the cover 2 moreover has a battery of its own—represented with a dashed line in FIGS. 2B and 11 and designated by the reference number 202—to which the aerial device is connected when it is housed within the respective cavity C made in the cover, so that it can be recharged immediately after its use, without any need to connect it to an external mains supply. For this purpose, the aerial device has external contacts 410 designed to be set in connection with corresponding contacts 232 present within the cavity C and connected to the battery.

It should be noted that the battery of the cover can also be used for recharging the cellphone, and the cover can hence also be provided with a connector—designated by 240 in FIGS. 1A, 2A, and 2B—designed to be connected to the supply port of the mobile device.

As may be seen once again in the above figures, the cover itself then has a port 242 for wired connection to an external mains supply, for recharging its own battery, and, moreover, the cover may also be configured so that, while it is connected to the mains supply, also the mobile device will at the same time be recharged.

It should again be noted that, in various preferred embodiments, the camera of the aerial device is mounted thereon so as to be orientable about an axis, manually or else via an electromechanical adjustment system (FIG. 9).

Moreover, in various preferred embodiments, the aforesaid camera can be driven by the mobile device also when the aerial device is put back into the cover, being thus able to constitute to all effects and purposes an additional camera of the mobile device. In this case, the communication between the mobile device and the aerial device can be established via the electrical connection that is set up between the two, through the cover, when all three apparatuses are joined together. In addition, the cover has in this case an opening through which the camera 6 housed in the cavity C faces outwards.

Again, in various preferred embodiments, the aerial device comprises a memory saved within which are the images taken by the camera, and the control unit of the mobile device may be configured in such a way that the images saved to the aforesaid memory can be transferred into the memory of the mobile device when the aerial device is put back into the cover, via the aforesaid electrical connection that is set up between the two devices through the cover.

The memory in question of the aerial device may be of an extractable type, for example in the SD (Secure Digital) format, and in this case the cover may envisage an input port for insertion of said memory, which is pre-arranged for connecting electrically up to the mobile device when this is housed within the cover. Alternatively, the saved images can be transferred to the mobile device via Wi-Fi or via a wired accessory.

In the light of what has been said above, there may be appreciated the infinite possibilities of use offered by the cover described herein and by the aerial device associated thereto. Evidently also included among these is the possibility of making the selfies described at the start. In this connection, the cover described herein is able to supplant completely the selfie sticks mentioned previously, overcoming on the other hand all the drawbacks that instead afflict the above known devices.

and the embodiments may vary, even significantly, with respect to what has been illustrated herein purely by way of non-limiting example, without thereby departing from the scope of the invention, as is defined in the annexed claims. For example, the aerial device may be connected to the cover or directly to the mobile device in wired mode and, in this case, hence, the transmission of the control signals from the mobile device to the aerial device, and of the images taken by the camera, in the reverse direction, may take place in wired mode, hence without any need to envisage for the aerial device a wireless communication interface.

1. A cover for a mobile device, comprising an aerial device provided with camera, which is removably housed within a cavity made in said cover.

2. The cover according to claim 1, comprising a battery to which said aerial device is connected when it is housed within said cover.

3. The cover according to claim 1, wherein said aerial device comprises a generically planar body, provided with through openings housed within which are rotors for propulsion of said aerial device.

4. The cover according to claim 3, wherein said rotors are each driven by annular electric motors.

5. The cover according to claim 4, wherein said annular electric motors comprise a first ring, which carries a series of windings of electrical wires and is fixed to said planar body at said opening, and a second ring forming a part of said rotor, which carries, on the outside, a series of magnetic elements designed to co-operate with said series of windings of electrical wires, and which carries, on the inside, the blades of said rotor.

6. The cover according to claim 3, wherein said rotors have a perimetral ring made on the outer edge of which is a toothing that is engaged by a gear wheel driven by said motor (42).

7. The cover according to claim 1, wherein said aerial device comprises a generally cylindrical body provided with one or more rotors set on top of one another.

8. The cover according to claim 7, wherein said rotors comprise blades oriented radially with respect to said cylindrical body and collapsible into a position against said body.

9. The cover according to claim 8, wherein said cylindrical body has a portion with reduced external diameter that defines a seat in which said blades are housed in the collapsed position against said body.

10. The cover according to any of claim 7, wherein said device comprises two counter-rotating rotors set on top of one another.

11. The cover according to claim 1, further comprising a shell or half-shell structure pre-arranged for housing said mobile device.

12. The cover according to claim 11, wherein said structure comprises a cavity removably housed in which is said aerial device.

13. The cover according to claim 12, further comprising electrical contacts positioned in said cavity, said electrical contacts, connected to a battery contained in said cover and are designed to be set in connection with electrical contacts positioned on the outside of said aerial device.

14. The cover according to claim 1, wherein said aerial device has a wireless communication interface for controlling said aerial device and sending images from said camera to said mobile device.

15. The cover according to claim 1, wherein said cavity is accessible from the outside at a first slit of said cover, through which said aerial device can be inserted within said cavity, and wherein said cavity is accessible at two further slits of said cover, which are configured for leaving exposed outwards two opposed underlying edges of said aerial device, in such a way that these can be gripped by the user for taking said aerial device out of said cavity.

16. The cover of claim 1, wherein said mobile device consists of a smartphone or a tablet computer.
